(19) United States
(12) Patent Application Publication
(10) Pub. No.: US 2026/0121753 A1
(43) Pub. Date: Apr. 30, 2026

(54) SIGNAL TRANSMISSION METHOD AND DEVICE, STORAGE MEDIUM, AND ELECTRONIC DEVICE

(71) Applicant: SUZHOU METABRAIN INTELLIGENT TECHNOLOGY CO., LTD., Suzhou, Jiangsu (CN)

(72) Inventors: Weikang ZHAO, Suzhou, Jiangsu (CN); Tanlong CI, Suzhou, Jiangsu (CN); Caikun YANG, Suzhou, Jiangsu (CN); Xianyang GAO, Suzhou, Jiangsu (CN)

(21) Appl. No.: 19/142,920

(22) PCT Filed: Jun. 20, 2024
(86) PCT No.: PCT/CN2024/100453

§ 371 Date: Jun. 24, 2025

(30) Foreign Application Priority Data
Nov. 29, 2023 (CN) 202311615383.9

(51) Int. Cl. H04B 10/50; H04B 10/25; H04Q 11/00

(52) U.S. Cl. CPC H04B 10/501; H04B 10/25; H04Q 11/0071

(57) ABSTRACT

The embodiments of the present application provide a signal transmitting method and device, a non-volatile readable storage medium and an electronic device. The method includes: when a first light emitting element has acquired a first electric signal, converting the first electric signal into a first optical signal, inputting the first optical signal into a first light-switching-switch unit, and outputting the first optical signal to an outputting port of the first light-switching-switch unit via a first optical passage, wherein the first electric signal is an electric signal of a first type, and the outputting port is connected to an optical fiber; and when a second light emitting element has acquired a second electric signal, by using the second light emitting element, converting the second electric signal into a second optical signal, inputting the second optical signal into the first light-switching-switch unit, and outputting the second optical signal to the outputting port of the first light-switching-switch unit via a second optical passage in the first light-switching-switch unit, wherein the second electric signal is an electric signal of a second type.

### CROSS-REFERENCE TO RELATED APPLICATION

The present application claims the priority of the Chinese patent application filed on November 29^{th}, 2023 before the Chinese Patent Office with the application number of 202311615383.9 and the title of “SIGNAL TRANSMISSION METHOD AND DEVICE, STORAGE MEDIUM, AND ELECTRONIC DEVICE”, which is incorporated herein in its entirety by reference.

### FIELD

The embodiments of the present application relate to the field of computers, and particularly relate to a signal transmitting method and device, a non-volatile readable storage medium and an electronic device.

### BACKGROUND

Currently, in order to satisfy the demands on high-speed interconnection, it is required to employ a mode of low-loss optical interconnection to construct the transmission path, to transmit the data signal. The traditional photo-electricity converting modules merely convert the high-speed data signal into an optical signal and transmit via an optical-fiber. However, some links (for example, a PCIe (Peripheral Component Interconnect Express, a high-speed serial computer expansion-bus standard) link) do not only transmit the high-speed data signal, but also are required to transmit low-speed auxiliary signals, wherein those low-speed auxiliary signals are signals necessary for supporting the link training, constructing the link and switching the link state. If such a type of the low-speed auxiliary signals is to be transmitted in the optical-fiber link, it is required that the low-speed auxiliary signals can pass through optical modules.

In the prior art, usually a mode of adding additional modules (for example, a chip or a FPGA (Field Programmable Gate Array)) or a mode of modulating the signal by using a pilot tone modulation technique is used, to transmit the high-speed data signal and the low-speed auxiliary signal. However, the mode of adding additional modules does not only add the additional device cost, but also reduces the effective data bandwidth of the devices, which affects the efficiency of the signal transmission. Moreover, although the mode of modulating the auxiliary signals to the respective independent data channels by using the pilot tone modulation technique can reduce the cost to a certain extent, it reduces the signal-to-noise ratio, and reduces the sensitivity of the receiver of the optical module, which also affects the efficiency of the signal transmission.

Therefore, the mode for signal transmission in the prior art has the problem of a low efficiency of the signal transmission.

### SUMMARY

The embodiments of the present application provide a signal transmitting method and device, a non-volatile readable storage medium and an electronic device, to at least solve the problem of a low efficiency of the signal transmission of the mode for signal transmission in the prior art.

According to an embodiment of the present application, there is provided a signal transmitting method, wherein the method comprises:
in response to a first light emitting element having acquired a first electric signal sent by a first device, by using the first light emitting element, converting the first electric signal into a first optical signal, inputting the first optical signal into a first light-switching-switch unit, and outputting the first optical signal to an outputting port of the first light-switching-switch unit via a first optical passage in the first light-switching-switch unit, wherein the first light emitting element is configured for converting an electric signal of a first type into an optical signal, the first electric signal is an electric signal of the first type, and the outputting port is connected to an optical fiber; and
in response to a second light emitting element having acquired a second electric signal sent by the first device, by using the second light emitting element, converting the second electric signal into a second optical signal, inputting the second optical signal into the first light-switching-switch unit, and outputting the second optical signal to the outputting port of the first light-switching-switch unit via a second optical passage in the first light-switching-switch unit, wherein the second light emitting element is configured for converting an electric signal of a second type into an optical signal, and the second electric signal is an electric signal of the second type.

According to another embodiment of the present application, there is provided a signal transmitting device, wherein the device comprises:
a first light emitting element configured for, in response to the first light emitting element having acquired a first electric signal sent by a first device, converting the first electric signal into a first optical signal, and inputting the first optical signal into a first light-switching-switch unit, wherein the first light emitting element is configured for converting an electric signal of a first type into an optical signal, and the first electric signal is an electric signal of the first type;
a second light emitting element configured for, in response to the second light emitting element having acquired a second electric signal sent by the first device, converting the second electric signal into a second optical signal, and inputting the second optical signal into the first light-switching-switch unit, wherein the second light emitting element is configured for converting an electric signal of a second type into an optical signal, and the second electric signal is an electric signal of the second type; and
the first light-switching-switch unit, connected to the first light emitting element and the second light emitting element, and configured for, in response to the first optical signal being inputted into the first light-switching-switch unit, outputting the first optical signal to an outputting port of the first light-switching-switch unit via a first optical passage in the first light-switching-switch unit, wherein the outputting port is configured for being connected to an optical fiber; and in response to the second optical signal being inputted into the first light-switching-switch unit, outputting the second optical signal to the outputting port via a second optical passage in the first light-switching-switch unit.

According to yet another embodiment of the present application, there is further provided a non-volatile computer-readable storage medium, wherein the non-volatile computer-readable storage medium stores a computer program, and the computer program is configured for, when executed, implementing the steps according to any one of the process embodiments stated above.

According to still another embodiment of the present application, there is further provided an electronic device, wherein the electronic device comprises a memory and a processor, the memory stores a computer program, and the processor is configured for executing the computer program to implement the steps according to any one of the process embodiments stated above.

By using the present application, by means of performing selective switching and transmission to the two types of signals by using the same one transmission link, according to the signal type of the acquired to-be-transmitted electric signal, the corresponding optical passage is switched to by using the light-switching-switch unit, to transmit the optical signal obtained by the conversion of the electric signal to the outputting port via the switched optical passage, and it is not required to construct optical-fiber channels for the two types of signals individually, which may reduce the cost of the transmission. In addition, by means of performing selective switching and transmission to the two types of signals by using the same one transmission link, mutual influence between the two types of signals may be prevented, to increase the sensitivity to the signals of the receiving side, and increase the efficiency of the signal transmission. Therefore, the problem of a low efficiency of the signal transmission of the mode for signal transmission in the prior art may be solved, to reach the technical effect of increasing the efficiency of the signal transmission.

### BRIEF DESCRIPTION OF THE DRAWINGS

FIG. 1 is a schematic diagram of the hardware environment of a signal transmitting method according to an embodiment of the present application.

FIG. 2 is a schematic flow chart of a signal transmitting method according to an embodiment of the present application.

FIG. 3 is a schematic diagram of a signal transmitting device according to an embodiment of the present application.

FIG. 4 is a schematic diagram of a light-switching-switch unit according to an embodiment of the present application.

FIG. 5 is a schematic diagram of another signal transmitting method according to an embodiment of the present application.

FIG. 6 is a schematic diagram of another signal transmitting method according to an embodiment of the present application.

FIG. 7 is a schematic diagram of another signal transmitting method according to an embodiment of the present application.

FIG. 8 is a schematic flow chart of another signal transmitting method according to an embodiment of the present application.

FIG. 9 is a schematic diagram of another signal transmitting method according to an embodiment of the present application.

FIG. 10 is a schematic diagram of another light-switching-switch unit according to an embodiment of the present application.

FIG. 11 is a schematic diagram of another signal transmitting method according to an embodiment of the present application.

FIG. 12 is a schematic diagram of a signal transmitting system according to an embodiment of the present application.

FIG. 13 is a schematic flow chart of another signal transmitting method according to an embodiment of the present application.

FIG. 14 is a schematic flow chart of another signal transmitting method according to an embodiment of the present application.

### DETAILED DESCRIPTION

The embodiments of the present application will be described in detail below with reference to the drawings and the embodiments.

It should be noted that the terms “target”, “second” and so on in the description, the claims and the drawings of the present application are intended to distinguish similar objects, and are not necessarily used to describe a particular order or sequence.

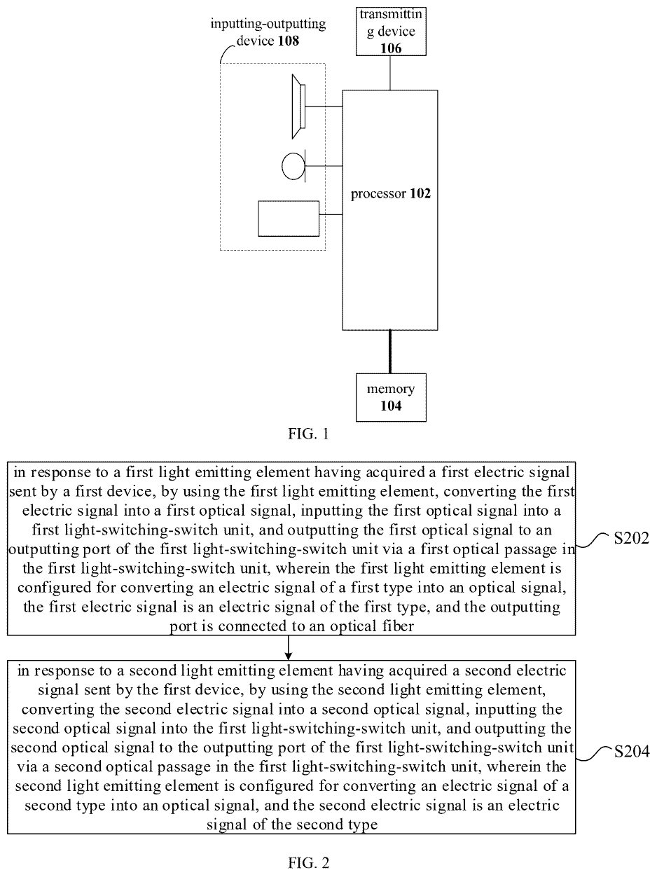

The process embodiments according to the embodiments of the present application may be implemented in a server device or a similar computing device. Taking the case as an example in which they are implemented in a server device, FIG. 1 is a block diagram of the hardware structure of a server device for a signal transmitting method according to an embodiment of the present application. As shown in FIG. 1, the server device may comprise one or more (FIG. 1 shows merely one) processors 102 (the processors 102 may include but are not limited to a processing device such as a microprocessor MCU or a programmable logic device FPGA) and a memory 104 configured for storing data. The server device may further comprise a transmitting device 106 for the communication function and an inputting-outputting device 108. A person skilled in the art can understand that the structure shown in FIG. 1 is merely illustrative, and does not limit the structure of the server device. For example, the server device may also comprise more or fewer components than those shown in FIG. 1, or have a different configuration from that shown in FIG. 1.

The memory 104 may be configured for storing a computer program, for example, the software programs and modules of an application software, for example, a computer program corresponding to the signal transmitting method according to the embodiments of the present application. The processors 102 execute the computer program stored in the memory 104, so as to execute various function applications and data processing, i.e., implementing the method stated above. The memory 104 may include a high-speed random access memory, and may also include a non-volatile memory, for example, one or more magnetic storing devices, flash memories, or other non-volatile solid-state memories. In some embodiments, the memory 104 may further include memories provided remotely to the processors 102, and those remote memories may be connected to the server device via a network. Examples of the network include but are not limited to the Internet, an enterprise intranet, a local area network, a mobile communication net and a combination thereof.

The transmitting device 106 is configured for receiving or emitting data via a network. Particular examples of the network may include a wireless network supplied by the communication supplier of the server device. In an embodiment, the transmitting device 106 comprises a network adaptor (Network Interface Controller, referred to for short as NIC), which may be connected to other network devices via a base station so as to communicate with the Internet. In an embodiment, the transmitting device 106 may be a Radio Frequency (referred to for short as RF) module, which is configured for communicating with the Internet wirelessly.

The present embodiment provides a signal transmitting method. FIG. 2 is a flow chart of a signal transmitting method according to an embodiment of the present application. As shown in FIG. 2, the flow comprises the following steps.

Step S202: in response to a first light emitting element having acquired a first electric signal sent by a first device, by using the first light emitting element, converting the first electric signal into a first optical signal, inputting the first optical signal into a first light-switching-switch unit, and outputting the first optical signal to an outputting port of the first light-switching-switch unit via a first optical passage in the first light-switching-switch unit, wherein the first light emitting element is configured for converting an electric signal of a first type into an optical signal, the first electric signal is an electric signal of the first type, and the outputting port is connected to an optical fiber.

Step S204: in response to a second light emitting element having acquired a second electric signal sent by the first device, by using the second light emitting element, converting the second electric signal into a second optical signal, inputting the second optical signal into the first light-switching-switch unit, and outputting the second optical signal to the outputting port of the first light-switching-switch unit via a second optical passage in the first light-switching-switch unit, wherein the second light emitting element is configured for converting an electric signal of a second type into an optical signal, and the second electric signal is an electric signal of the second type.

The signal transmitting method according to the present embodiment may be applied in scenes of the transmission of a PCIe data signal. PCIe is a high-speed serial computer expansion-bus standard, and is mainly used to expand the data throughput of a computer system bus and increase the equipment communication speed. Currently, the transmission path of a PCIe data signal is constructed mainly in the mode of electric interconnection, and comprises PCB-board-level copper wires and copper cables. With the continuous updating of the PCIe protocol, the problem of loss caused by the electric interconnection is increasingly more serious, and the signal transmission distance that the electric interconnection can realize gradually reduces. Regarding the PCIe 5.0 speed signals, the traditional external copper cables can merely realize interconnection of the length level of meters. For the demands on high-speed interconnection at the inter-cabinet level of current data centers or supercomputing centers, the optical interconnection, which has a low loss, is currently the optimum solution.

Because the corresponding standards of the optical modules are not established for the PCIe protocol, some provisions in the PCIe protocol are not compatible with the existing standards of the optical modules, which causes that the construction of a PCIe optical-interconnection passage directly using the optical modules fails. The traditional photo-electricity converting modules merely convert the high-speed data signal into an optical signal and transmit via an optical-fiber. However, a PCIe link does not only transmit the high-speed data signal, but also is required to transmit low-speed auxiliary signals, wherein those low-speed auxiliary signals are signals necessary for supporting the PCIe link training, constructing the link and switching the link state. The traditional copper cables can directly transmit the low-speed auxiliary signals, but, if such a type of the low-speed auxiliary signals is to be transmitted in the optical-fiber link, it is required that the low-speed auxiliary signals can pass through optical modules. Regarding a high-speed photo-electricity converting device, its built-in DSP chip usually supports merely high-speed signals of particular speeds, and cannot transmit such low-speed auxiliary signals.

In the related art, the PCIe link signals are usually transmitted in the following several manners. As an alternative embodiment, a converting chip is used to compile the low-speed auxiliary signal, such as a clock signal, into an LVDS (Low-Voltage Differential Signaling) having a higher speed, which is subsequently transmitted by using independent optical module and optical-fiber link. As an alternative embodiment, the PCIe auxiliary signal is transmitted by using a pilot tone modulation technique. The emitting side, when sending the auxiliary signal, by using a controller, regulates an optical-module laser-light driver in the data link, converts the auxiliary signal into a low-frequency sine or cosine modulated signal of a small amplitude, and superposes into a predetermined corresponding high-speed data signal. An opposite-side optical module can obtain the corresponding auxiliary-signal information after parsing out the modulated signal. As an alternative embodiment, the low-speed auxiliary signal is compiled to a higher speed by using a FPGA, and subsequently redundant laser generators of a CXP (a hot-plugged high-density parallel optical module standard) optical module are used to perform photovoltaic conversion to the auxiliary signal obtained by the compiling by the FPGA, which is subsequently transmitted via an optical fiber.

However, the methods of processing the auxiliary signal by using a converting chip or a FPGA and subsequently transmitting it via an independent optical-fiber link require additional photovoltaic signal converting devices and optical-fiber channels, which does not only add the additional device cost, but also reduces the effective data bandwidth of the devices. The modulation of the auxiliary signals to the respective independent data channels by using the pilot tone modulation technique does not require independent devices and optical-fiber channels. However, such a method reduces the signal-to-noise ratio, and reduces the sensitivity of the receiver of the optical module. Especially, in the PCIe 6.0 protocol the high-speed data signals employ the PAM4 (4-Level Pulse Amplitude Modulation) modulating mode, and the pilot tone modulation technique significantly increases the bit error rate, and is thus unusable.

In order to at least partially solve the above problem, in the present embodiment, a combination of a high-speed light emitting element and a low-speed light emitting element may be used to realize the optical-signal conversion of a high-speed data signal and a low-speed auxiliary signal in the PCIe protocol, wherein the transmission of the low-speed auxiliary signal uses the optical-fiber link of the transmission of the high-speed data signal, which may effectively reduce the cost of the optical-fiber link. Moreover, a light-switching-switch unit is used to realize a selective switching and transmission of the high-speed data signal and the low-speed auxiliary signal, which may avoid operating the high-speed data electric-signal to reduce the signal quality, and increase the sensitivity of the receiver of the optical module, thereby increasing the efficiency of the signal transmission.

It should be noted that the light-switching-switch unit according to the present embodiment may be a silicon-based light-switching-switch unit, the electric signal of the first type may be a high-speed data signal (i.e., a signal whose transmission frequency is greater than a preset threshold), and the electric signal of the second type may be a low-speed auxiliary electric-signal (i.e., a signal whose transmission frequency is less than the preset threshold). The preset threshold herein may be 100 MHz. Correspondingly, the first light emitting element may be a high-speed light emitting element, and the second light emitting element may be a low-speed light emitting element. The outputting port corresponds to the transmission entrance of the optical fiber. The high-speed light emitting element may be a high-speed light emitting device with a high bandwidth, and the low-speed light emitting element may be a low-speed light emitting element with a low bandwidth.

Optionally, an MCU (Microcontroller Unit) may be used to determine whether the electric signal currently acquired is a signal of the first type or the second type.

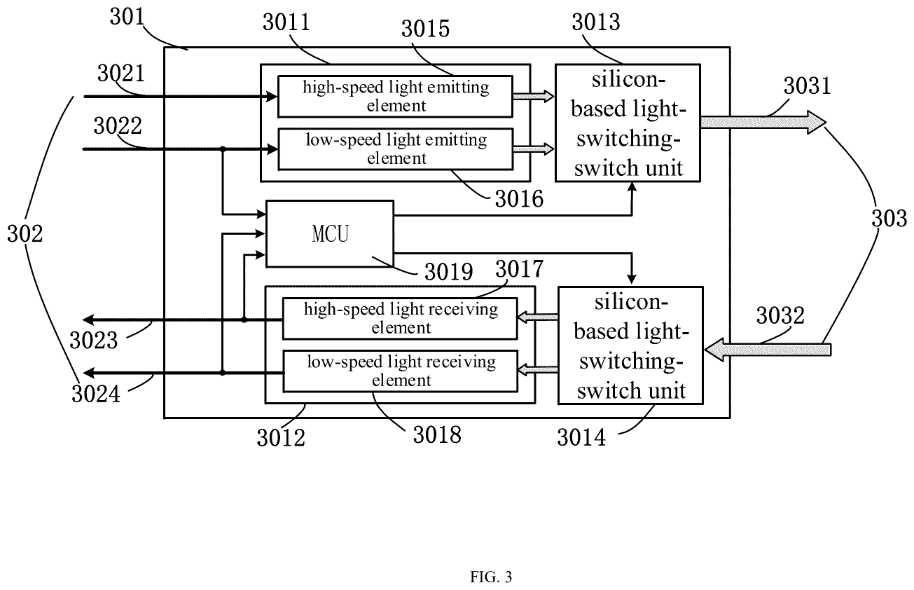

As shown in FIG. 3, FIG. 3 is a schematic diagram of the device that transmits the optical signal in the PCIe protocol, in which 301 is a photo-electricity converting module, 302 is an electric link, and 303 is an external optical-fiber link. In the photo-electricity converting module, 3011 is a light emitting unit, 3012 is a light receiving unit, 3013 is a silicon-based light-switching-switch unit at the emitting side, 3014 is a silicon-based light-switching-switch unit at the receiving side, 3015 is a high-speed light emitting element, 3016 is a low-speed light emitting element, 3017 is a high-speed light receiving element, 3018 is a low-speed light receiving element, and 3019 is an MCU microcontroller. In the electric link, 3021 is a high-speed-signal electric-link at the light emitting side, 3022 is a low-speed-signal electric-link at the light emitting side, 3023 is a high-speed-signal electric-link at the light receiving side, and 3024 is a low-speed-signal electric-link at the light receiving side. In the external optical-fiber link, 3031 is an optical fiber at the light emitting side, and 3032 is an optical fiber at the light receiving side.

When the device is sending a high-speed data signal or low-speed auxiliary signal in the PCIe protocol via the optical-fiber link, the MCU microcontroller detects the low-speed-signal electric-link and determines whether the current link is transmitting a low-speed auxiliary signal. If it is not detected that a low-speed auxiliary electric-signal is transmitted in the low-speed-signal electric-link, the MCU microcontroller controls a driver in the silicon-based light-switching-switch unit at the emitting side, to transmit via the optical fiber outwardly the high-speed data optical-signal that has been transmitted in via the high-speed light emitting element. If it is detected that a low-speed auxiliary electric-signal is transmitted in the low-speed-signal electric-link, the MCU microcontroller controls a driver in the silicon-based light-switching-switch unit at the emitting side, to switch the optical passage, and transmit via the optical fiber outwardly the low-speed auxiliary optical-signal that has been transmitted in via the low-speed light emitting element.

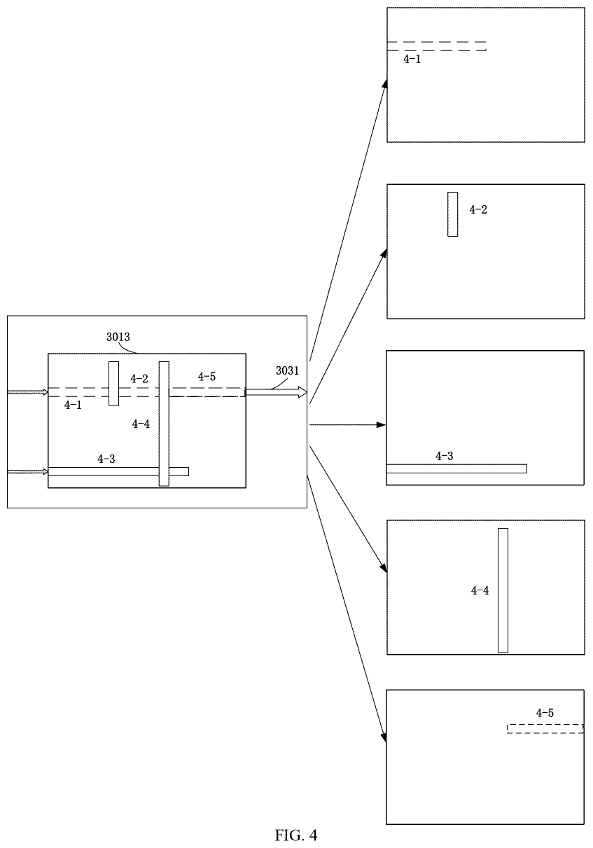

It should be noted that the first optical passage according to the present embodiment corresponds to an optical-transmission passage of the high-speed data signal, and the second optical passage corresponds to an optical-transmission passage of the low-speed auxiliary signal. As shown in FIG. 4, the light-switching-switch unit may comprise two optical passages, wherein the black color and the light gray color correspond to the first optical passage, and the deep gray color and the light gray color correspond to the second optical passage.

Optionally, the method further comprises:
while the first optical signal is being outputted to the outputting port via the first optical passage, controlling the second optical passage to be in a disconnecting state.

Optionally, the method further comprises:
while the second optical signal is being outputted to the outputting port via the second optical passage, controlling the first optical passage to be in a disconnecting state.

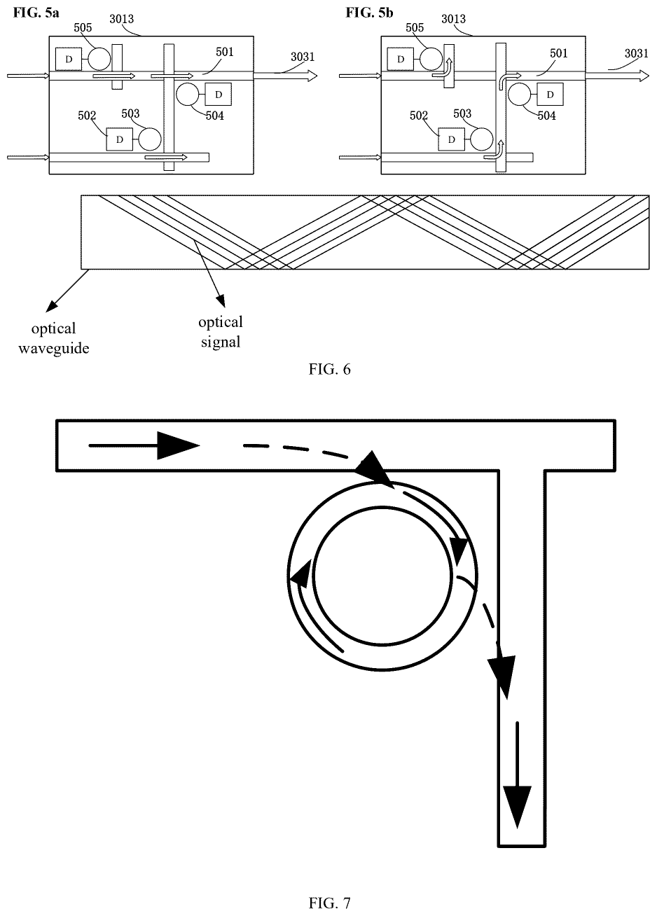

It should be noted that the disconnecting state may refer to that the optical passage and the outputting port have no connection therebetween, and in an optical passage in the disconnecting state, the optical signal cannot be transmitted to the outputting port (i.e., the optical-fiber entrance). As shown in FIG. 5, in the part (a) of FIG. 5, the first optical signal may be outputted to the outputting port via the first optical passage, at which point the second optical passage is in the disconnecting state, and the optical signal cannot be outputted to the outputting port via the second optical passage. In the part (b) of FIG. 5, the second optical signal may be outputted to the outputting port via the second optical passage, at which point the first optical passage is in the disconnecting state, and the optical signal cannot be outputted to the outputting port via the first optical passage.

By using the configuration of the combination and co-encapsulation of the high-speed light element and the low-speed light element, in an aspect, it may be prevented that the low-speed signal occupies an additional photo-electricity converting module, and, in another aspect, it may be prevented that the low-speed signal is superposed to the transmission of the high-speed signal, which affects the signal quality of the high-speed signal.

Optionally, the high-speed light emitting element and the low-speed light emitting element are used to convert an electric signal into an optical signal, and they may be elements of the same performances, and may also be elements of different performances. The high-speed light receiving element and the low-speed light receiving element are used to convert an optical signal into an electric signal, and they may be elements of the same performances, and may also be elements of different performances. The light emitting unit and the silicon-based light-switching-switch unit at the emitting side may be directly coupled, and may also be coupled by using optical fibers, to realize the transmission of the optical signal. The light receiving unit and the silicon-based light-switching-switch unit at the receiving side may be directly coupled, and may also be coupled by using optical fibers, to realize the transmission of the optical signal. The quantity of the high-speed light emitting element and the quantity of the low-speed light emitting element in the light emitting unit may be equal, and may also be unequal. The quantity of the high-speed light receiving element and the quantity of the low-speed light receiving element in the light receiving unit may be equal, and may also be unequal.

The encapsulation of the photo-electricity converting device may employ the encapsulation of existing optical modules, and may also be configured to be an onboard optical module. The combination of the quantities of the high-speed element and the low-speed element in the light emitting unit and the light receiving unit inside the photo-electricity converting device is flexible, facilitates expansion, and facilitates the optical-signal interconnection between PCIe-protocol devices.

Optionally, the method according to the present embodiment may also be used for the transmission of the optical signals in the high-speed serial protocols such as CXL (Compute Express Link, an open industrial standard for high-bandwidth low-delay device interconnection) and UCIe (Universal Chiplet Interconnect Express, or universal small-chip interconnection channel).

By using the above steps, by, in response to a first light emitting element having acquired a first electric signal sent by a first device, by using the first light emitting element, converting the first electric signal into a first optical signal, inputting the first optical signal into a first light-switching-switch unit, and outputting the first optical signal to an outputting port of the first light-switching-switch unit via a first optical passage in the first light-switching-switch unit, wherein the first light emitting element is configured for converting an electric signal of a first type into an optical signal, the first electric signal is an electric signal of the first type, and the outputting port is connected to an optical fiber; and in response to a second light emitting element having acquired a second electric signal sent by the first device, by using the second light emitting element, converting the second electric signal into a second optical signal, inputting the second optical signal into the first light-switching-switch unit, and outputting the second optical signal to the outputting port of the first light-switching-switch unit via a second optical passage in the first light-switching-switch unit, wherein the second light emitting element is configured for converting an electric signal of a second type into an optical signal, and the second electric signal is an electric signal of the second type, the problem of a low efficiency of the signal transmission of the mode for signal transmission in the prior art is solved, thereby increasing the efficiency of the signal transmission.

The subject of the implementation of the above steps may be a server, a terminal and so on, but is not limited thereto.

In an illustrative embodiment, the method further comprises Steps S11-S12.

S11: in response to the first light emitting element having acquired the first electric signal sent by the first device and the second light emitting element having acquired the second electric signal sent by the first device, inputting the second optical signal into the first light-switching-switch unit, and determining whether the whole of the second electric signal has been outputted to the outputting port.

S12: in response to it having been determined that the whole of the second electric signal has been outputted to the outputting port, inputting the first optical signal into the first light-switching-switch unit.

In order to prevent frequent switching of the states of the first optical passage and the second optical passage by the light-switching-switch unit, in the present embodiment, when it is detected that the second electric signal exists in the electric signals sent by the first device, the method may comprise firstly transmitting the second electric signal and disconnecting the first optical passage, till it has been determined that the whole of the second electric signal has been completely transmitted (in other words, no second electric signal is in the electric signals sent by the first device), subsequently disconnecting the second optical passage, and starting to transmit the first electric signal.

It should be noted that, regarding the photo-electricity converting module emitting the optical signal, whether the second electric signal exists in the electric signals may be determined by detecting by the MCU whether an electric signal is transmitted in the low-speed-signal electric-link, and may also be determined by directly detecting by the MCU the transmission frequency of the electric signal sent by the device that is currently acquired.

By using the present embodiment, when it is detected that the device simultaneously sends the high-speed data signal and the low-speed auxiliary signal, the method may comprise firstly switching to the optical passage transmitting the low-speed auxiliary signal, and, after the low-speed auxiliary signal has been completely transmitted, subsequently transmitting the high-speed data signal, which prevents frequent switching of the states of the first optical passage and the second optical passage by the light-switching-switch unit.

In an illustrative embodiment, the step of outputting the first optical signal to the outputting port of the first light-switching-switch unit via the first optical passage in the first light-switching-switch unit comprises Step S21.

S21: controlling the first optical passage to be in a conducting state, and outputting the first optical signal to the outputting port via the first optical passage.

It should be noted that the conducting state may refer to that the optical passage and the outputting port have a connection therebetween, or the optical signal can be transmitted along the whole of the path of the corresponding optical passage, and in an optical passage in the conducting state, the optical signal can be transmitted to the outputting port along the whole of the path of the corresponding optical passage.

It should be noted that the conducting state may refer to that the optical passage and the outputting port have a connection therebetween, or the optical signal can be transmitted along the whole of the path of the corresponding optical passage, and in an optical passage in the conducting state, the optical signal can be transmitted to the outputting port along the whole of the path of the corresponding optical passage.

Optionally, the step of controlling the first optical passage to be in the conducting state comprises:
controlling a first optical-waveguide group in the first optical passage to be in a directly-going-through state, wherein when the first optical-waveguide group is in the directly-going-through state, the first optical passage is in the conducting state, and the first optical-waveguide group comprises one or more optical waveguides.

It should be noted that the transmission of the optical signals in the photo-electricity converting module according to the present embodiment may be performed by using optical waveguides. As shown in FIG. 6, by the continuous reflection of the optical signals in the optical waveguide, the transmission of the optical signals can be realized. The first optical passage may be formed by a first optical-waveguide group. As shown in FIG. 4, the first optical-waveguide group may comprise one optical waveguide; in other words, the passage denoted by 4-1, 4-2 and 4-5 in FIG. 4 is formed by one optical waveguide. The first optical-waveguide group may also comprise a plurality of optical waveguides; in other words, the passages denoted by 4-1 and 4-2 in FIG. 4 individually correspond to two optical waveguides, and the passage denoted by 4-5 corresponds to one optical waveguide.

The directly-going-through state may refer to a transmission state in which the direction of the transmission of the optical signal in the optical waveguide is the same as the mode when it enters the optical waveguide. That the first optical-waveguide group is in the directly-going-through state may refer to that the optical signal is transmitted in the first optical-waveguide group in the direction in which it enters the optical waveguide.

Optionally, the method further comprises:
while the first optical-waveguide group in the first optical passage is being controlled to be in the directly-going-through state, controlling other optical waveguides than a first target optical waveguide in a second optical-waveguide group in the second optical passage to be in the directly-going-through state, wherein the first target optical waveguide is an optical waveguide comprised by both of the first optical-waveguide group and the second optical-waveguide group, and when the second optical-waveguide group is in the directly-going-through state, the second optical passage is in a disconnecting state; or
while the first optical-waveguide group in the first optical passage is being controlled to be in the directly-going-through state, controlling at least part of other optical waveguides than a first target optical waveguide in a second optical-waveguide group in the second optical passage to be in a deflecting state, wherein when the at least part of the optical waveguides in the second optical-waveguide group are in the deflecting state, the second optical passage is in a disconnecting state.

It should be noted that the second optical passage may be formed by a second optical-waveguide group. As shown in FIG. 4, the second optical-waveguide group may comprise a plurality of optical waveguides; in other words, the passages denoted by 4-3 and 4-4 in FIG. 4 individually correspond to two optical waveguides, and the passage denoted by 4-5 corresponds to one optical waveguide. The first target optical waveguide may be an optical waveguide comprised by both of the first optical-waveguide group and the second optical-waveguide group, i.e., the optical waveguide corresponding to the passage denoted by 4-5 in FIG. 4.

When it is required to control the first optical-waveguide group in the first optical passage to be in the directly-going-through state, the second optical-waveguide group in the second optical passage may be controlled to be also in the directly-going-through state. Because an optical waveguide in the directly-going-through state can transmit the optical signal merely in the direction in which the optical signal enters the optical waveguide, when the second optical-waveguide group is in the directly-going-through state, the second optical signal transmitted out of the second light emitting element can be transmitted merely inside part of the optical waveguides in the second optical-waveguide group, cannot enter the optical waveguide shown in FIG. 4 that corresponds to 4-4 connected to the target optical waveguide in the second optical-waveguide group, and thus cannot enter the target optical waveguide and be transmitted, and the second optical passage is in the disconnecting state.

In addition, when the first optical-waveguide group in the first optical passage is controlled to be in the directly-going-through state, in order to prevent the second optical-waveguide group from transmitting part of the second optical signal to the outputting port, which affects the quality of the transmission of the first optical signal, the method may comprise controlling the first optical-waveguide group in the first optical passage to be in the directly-going-through state, and controlling at least part of other optical waveguides than the first target optical waveguide in the second optical-waveguide group in the second optical passage to be in the deflecting state.

The deflecting state may refer to a transmission state in which the direction of the transmission of the optical signal in the optical waveguide is different from the mode when it enters the optical waveguide. When the at least part of the optical waveguides in the second optical-waveguide group are in the deflecting state, the optical signal transmitted into the second optical-waveguide group can be deflected to other waveguides that do not have a connection relation with the outputting port.

Optionally, the step of controlling the first optical-waveguide group in the first optical passage to be in the directly-going-through state comprises:
in response to the first optical-waveguide group comprising the optical waveguides of a quantity N and in the first light-switching-switch unit drivers of the quantity N and resonators of the quantity N being provided, controlling the drivers of the quantity N to be in a non-operating state, wherein N is a positive integer greater than or equal to 1, and in response to an i-th driver among the drivers of the quantity N being in the non-operating state, the i-th driver is configured for stopping driving an i-th resonator among the resonators of the quantity N, to cause an i-th optical waveguide among the optical waveguides of the quantity N to be in the directly-going-through state, wherein i is a positive integer greater than or equal to 1 and less than or equal to N.

In the present embodiment, the directly-going-through state and the deflecting state of the optical waveguides may be switched by using drivers and resonators. One driver can drive one resonator to cause the optical waveguide to be in the deflecting state, and, by the deflection by the resonator, the direction of the transmission of the optical signal can be changed. The resonator may be a micro-ring resonator. The micro-ring resonator and the optical waveguide have an ultra-fast response characteristic, and, by using the ultra-fast response characteristic of them, the influence on the signal transmission by the switching between the transmission channels may be reduced to the largest extent, to increase the efficiency of the signal transmission.

As shown by the part a in FIG. 5, the MCU microcontroller controls the drivers in the silicon-based light-switching-switch unit 3013 at the emitting side (the reference signs D (Drive, or driver) the same as the drivers 502 in FIG. 5 individually correspond to the drivers at the different optical waveguides), to drive a first micro-ring resonator 505 and a second micro-ring resonator 504 to cause a first optical waveguide 501 to be in the directly-going-through state, to transmit via an optical fiber 3031 outwardly the high-speed data optical-signal that has been transmitted in via the high-speed light emitting element.

Optionally, the step of controlling the at least part of the other optical waveguides than the first target optical waveguide in the second optical-waveguide group in the second optical passage to be in the deflecting state comprises:
in response to the other optical waveguides than the first target optical waveguide in the second optical-waveguide group including the optical waveguides of a quantity M and in the first light-switching-switch unit drivers of the quantity M and resonators of the quantity M being provided, controlling the drivers of a quantity P among the drivers of the quantity M to be in an operating state, wherein M is a positive integer greater than or equal to 1, P is a positive integer greater than or equal to 1 and less than or equal to M, and in response to a j-th driver among the drivers of the quantity M being in the operating state, the j-th driver is configured for driving a j-th resonator among the resonators of the quantity M to cause a j-th optical waveguide among the optical waveguides of the quantity M to be in the deflecting state, wherein j is a positive integer greater than or equal to 1 and less than or equal to M; and the at least part of the optical waveguides include the optical waveguides of the quantity P among the optical waveguides of the quantity M, and in response to one driver among the drivers of the quantity P being in the operating state, the one driver among the drivers of the quantity P is configured for driving one resonator among the resonators of the quantity P among the resonators of the quantity M to cause one optical waveguide among the optical waveguides of the quantity P to be in the deflecting state.

It should be noted that a driver in the operating state can drive a resonator to cause the optical waveguide to be in the deflecting state. The optical waveguide in the deflecting state is as shown in FIG. 7, and the direction of the transmission of the optical signal can be deflected. A driver in the non-operating state can drive a resonator to cause the optical waveguide to be in the directly-going-through state.

By using the present embodiment, by using the characteristics of the resonator formed by the micro-ring resonator and the optical waveguide of a small size and a quick response, that facilitates the integrated deployment of the photo-electricity converting device, and may realize quick switching and controlling of the transmission path of the optical signal, which merely requires the optical fibers required by the transmission of the high-speed optical signal, and saves the optical fibers required by the transmission of the low-speed auxiliary signal.

In an illustrative embodiment, the step of outputting the second optical signal to the outputting port of the first light-switching-switch unit via the second optical passage in the first light-switching-switch unit comprises Step S31.

S31: controlling the second optical passage to be in a conducting state, and outputting the second optical signal to the outputting port via the second optical passage.

In the present embodiment, while the second optical signal is being outputted to the outputting port of the first light-switching-switch unit via the second optical passage in the first light-switching-switch unit, it is required to control the second optical passage to be in the conducting state. Correspondingly, at this point, the first optical passage corresponding to the first optical signal may be in the disconnecting state.

Optionally, the step of controlling the second optical passage to be in the conducting state comprises:
controlling a second optical-waveguide group in the second optical passage to be in a deflecting state, wherein when the second optical-waveguide group is in the deflecting state, the second optical passage is in the conducting state, and the second optical-waveguide group comprises one or more optical waveguides.

It should be noted that the deflecting state of the second optical-waveguide group according to the present embodiment may be different from the deflecting state of the at least part of the other optical waveguides than the first target optical waveguide in the second optical-waveguide group according to the above present embodiment. In other words, the two deflecting states can individually change the transmission direction of the optical signal to different directions.

As shown by the part b in FIG. 5, if it is detected that a low-speed auxiliary electric-signal is transmitted in the low-speed-signal electric-link, the MCU microcontroller controls the drivers in the silicon-based light-switching-switch unit 3013 at the emitting side, to drive the micro-ring resonators to cause the optical waveguides to be in the deflecting states, switch the passages of the optical waveguides, and transmit via the optical fiber outwardly the low-speed auxiliary optical-signal that has been transmitted in via the low-speed light emitting element, and the low-speed auxiliary optical-signal, by the effect of a third micro-ring resonator 503 and the second micro-ring resonator 504, enters the optical fiber 3031.

Optionally, the step of controlling the second optical-waveguide group in the second optical passage to be in the deflecting state comprises:
in response to the second optical-waveguide group comprising the optical waveguides of a quantity K and in the first light-switching-switch unit drivers of the quantity K and resonators of the quantity K being provided, controlling the drivers of the quantity K to be in an operating state, wherein K is a positive integer greater than 1, and in response to a t-th driver among the drivers of the quantity K being in the operating state, the t-th driver is configured for driving a t-th resonator among the resonators of the quantity K to cause a t-th optical waveguide among the optical waveguides of the quantity K to be in the deflecting state, wherein t is a positive integer greater than or equal to 1 and less than or equal to K.

It should be noted that the optical waveguides of the quantity K include the optical waveguides of the quantity M and the first target optical waveguide, other optical waveguides than the first target optical waveguide in the second optical-waveguide group include the optical waveguides of the quantity M, and the first target optical waveguide is an optical waveguide comprised by both of the first optical-waveguide group and the second optical-waveguide group.

The resonators of the quantity K may correspond to the third micro-ring resonator 503 and the second micro-ring resonator 504 in FIG. 5.

Optionally, the method further comprises:
while the second optical-waveguide group in the second optical passage is being controlled to be in the deflecting state, controlling at least part of other optical waveguides than a first target optical waveguide in a first optical-waveguide group in the first optical passage to be in the deflecting state, wherein the first target optical waveguide is an optical waveguide comprised by both of the first optical-waveguide group and the second optical-waveguide group, and when the at least part of the other optical waveguides than the first target optical waveguide in the first optical-waveguide group are in the deflecting state, the first optical passage is in a disconnecting state.

It should be noted that, in the transmission of the second optical signal, in order to prevent mutual interference between the first optical signal and the second optical signal, while the second optical-waveguide group in the second optical passage is being controlled to be in the deflecting state to transmit the second optical signal, it is further required to control at least part of other optical waveguides than the first target optical waveguide in the first optical-waveguide group in the first optical passage to be in the deflecting state. As shown in FIG. 5, the first optical signal, by the effect of the first micro-ring resonator 505, enters an optical waveguide that has no connection relation with the optical fiber 3031. The deflecting state here may be similar to that described in the above embodiment, and is not discussed further in the present embodiment.

That the at least part of the other optical waveguides than the first target optical waveguide in the first optical-waveguide group are in the deflecting state is in order to control the first optical passage to be in the disconnecting state, i.e., to cause the first optical signal to be incapable of being transmitted into the first target optical waveguide.

Optionally, the step of controlling the at least part of the other optical waveguides than the first target optical waveguide in the first optical-waveguide group in the first optical passage to be in the deflecting state comprises:
in response to the other optical waveguides than the first target optical waveguide in the first optical-waveguide group including the optical waveguides of a quantity T and in the first light-switching-switch unit drivers of the quantity T and resonators of the quantity T being provided, controlling the drivers of a quantity Q among the drivers of the quantity T to be in an operating state, wherein T is a positive integer greater than or equal to 1, Q is a positive integer greater than or equal to 1 and less than or equal to T, and in response to a k-th driver among the drivers of the quantity T being in the operating state, the k-th driver is configured for driving a k-th resonator among the resonators of the quantity T to cause a k-th optical waveguide among the optical waveguides of the quantity T to be in the deflecting state, wherein k is a positive integer greater than or equal to 1 and less than or equal to T; and the at least part of the optical waveguides include the optical waveguides of the quantity Q among the optical waveguides of the quantity T, and in response to one driver among the drivers of the quantity Q being in the operating state, the one driver among the drivers of the quantity Q is configured for driving one resonator among the resonators of the quantity Q among the resonators of the quantity T to cause one optical waveguide among the optical waveguides of the quantity Q to be in the deflecting state.

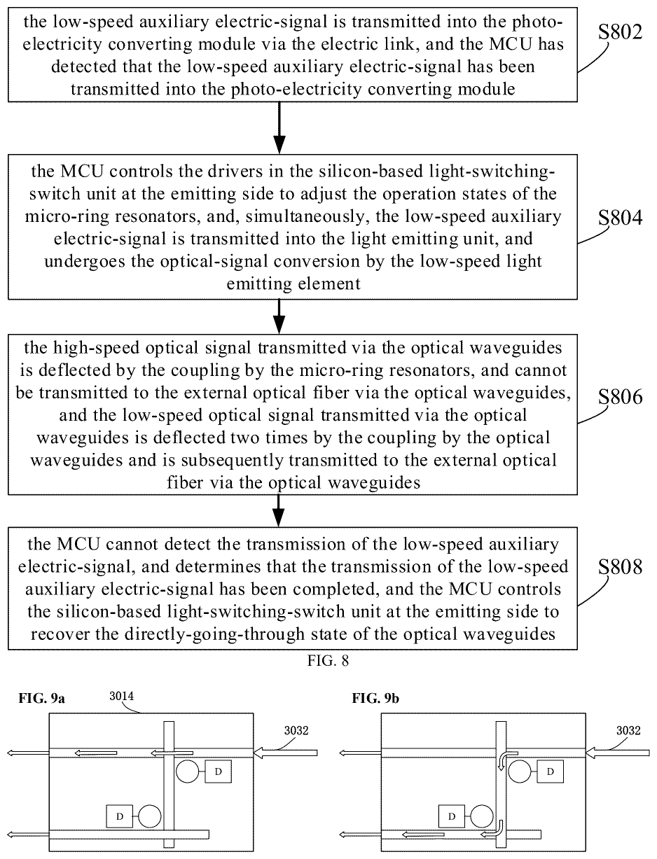

In the present embodiment, the process of the transmission switching to the signals by the emitting side may comprise Steps S802-S808 in the flow chart shown in FIG. 8.

Step S802: the low-speed auxiliary electric-signal is transmitted into the photo-electricity converting module via the electric link, and the MCU has detected that the low-speed auxiliary electric-signal has been transmitted into the photo-electricity converting module.

Step S804: the MCU controls the drivers in the silicon-based light-switching-switch unit at the emitting side to adjust the operation states of the micro-ring resonators, and, simultaneously, the low-speed auxiliary electric-signal is transmitted into the light emitting unit, and undergoes the optical-signal conversion by the low-speed light emitting element.

Step S806: the high-speed optical signal transmitted via the optical waveguides is deflected by the coupling by the micro-ring resonators, and cannot be transmitted to the external optical fiber via the optical waveguides, and the low-speed optical signal transmitted via the optical waveguides is deflected two times by the coupling by the optical waveguides and is subsequently transmitted to the external optical fiber via the optical waveguides.

Step S808: the MCU cannot detect the transmission of the low-speed auxiliary electric-signal, and determines that the transmission of the low-speed auxiliary electric-signal has been completed, and the MCU controls the silicon-based light-switching-switch unit at the emitting side to recover the directly-going-through state of the optical waveguides.

By using the present embodiment, in the transmission of the second optical signal, the second optical-waveguide group in the second optical passage is controlled to be in the deflecting state, to conduct the second optical passage, and controlling at least part of other optical waveguides than the first target optical waveguide in the first optical-waveguide group to be in the deflecting state, to disconnect the first optical passage, mutual interference between the two different types of optical signals may be prevented, to increase the success rate of the signal transmission.

In an illustrative embodiment, the method further comprises Steps S41-S42.

S41: in response to an inputting port of a second light-switching-switch unit having received a third optical signal transmitted via an optical fiber, outputting the third optical signal to a first light receiving element via a third optical passage in the second light-switching-switch unit, and by using the first light receiving element, converting the third optical signal into a third electric signal, wherein the first light receiving element is configured for converting an optical signal into an electric signal of the first type, and the third electric signal is an electric signal of the first type.

S42: in response to the inputting port of the second light-switching-switch unit having received a fourth optical signal transmitted via an optical fiber, outputting the fourth optical signal to a second light receiving element via a fourth optical passage in the second light-switching-switch unit, and by using the second light receiving element, converting the fourth optical signal into a fourth electric signal, wherein the second light receiving element is configured for converting an optical signal into an electric signal of the second type, and the fourth electric signal is an electric signal of the second type.

It should be noted that a device may emit the signal by using the photo-electricity converting module, and may also receive the signal by using the photo-electricity converting module. The photo-electricity converting module that emits the signal and the photo-electricity converting module that receives the signal may be the same one module (as shown in FIG. 3, the light emitting unit and the light receiving unit are in one module), and may also be different modules. The light emitting unit and the light receiving unit may individually correspond to one light-switching-switch unit.

In addition, the light receiving unit may, as the same as the light emitting unit, comprise receiving elements that process different types of signals. Because the two types require different bandwidths and hardware requirements, in order to ensure the efficiency of the signal processing, after the second light-switching-switch unit corresponding to the light receiving unit has received the optical signal, it may be determined, according to the type of the optical signal, to transmit the optical signal to the corresponding light receiving element.

The third optical passage may be the passage from the light-switching-switch unit to the light receiving element corresponding to the electric signal of the first type. When the first type is the high-speed data signal, the third optical passage is the passage of the optical signal from the light-switching-switch unit to the high-speed light receiving element, i.e., the high-speed data link. The fourth optical passage may be the passage from the light-switching-switch unit to the light receiving element corresponding to the electric signal of the second type. When the second type is the low-speed auxiliary signal, the fourth optical passage is the passage of the optical signal from the light-switching-switch unit to the low-speed light receiving element, i.e., the low-speed controlling link.

By using the present embodiment, the high-speed data signal undergoes the optical-signal conversion by using the high-speed light emitting device with a high bandwidth, and the low-speed auxiliary signal undergoes the optical-signal conversion by using the low-speed light emitting element with a low bandwidth, which may effectively reduce the cost of the photo-electricity converting device.

In an illustrative embodiment, the method further comprises Steps S51-S54.

S51: in response to the inputting port of the second light-switching-switch unit having received a target optical signal transmitted via an optical fiber, outputting the target optical signal to the first light receiving element via the third optical passage, and by using the first light receiving element, converting the target optical signal into a target electric signal.

S52: acquiring a first transmission frequency of the target electric signal.

S53: in response to the first transmission frequency being less than a preset frequency threshold, determining the target electric signal to be an electric signal of the second type, and determining an optical signal after a moment when the inputting port of the second light-switching-switch unit has received the target optical signal to be the third optical signal.

S54: in response to the first transmission frequency being greater than or equal to the preset frequency threshold, determining the target electric signal to be an electric signal of the first type, and determining the optical signal after the moment when the inputting port of the second light-switching-switch unit has received the target optical signal to be the fourth optical signal.

Taking into consideration that it is difficult to, according to the optical signal, determine the type of the electric signal corresponding thereto, and the first light receiving element, as the element receiving the high-speed data signal, can provide higher bandwidth and transmission efficiency for the signals, in the present embodiment, the method may comprise firstly transmitting the received optical signal to the first light receiving element corresponding to the first type, converting the optical signal by the first light receiving element, and, according to the electric signal outputted by the first light receiving element, determining the type of the current signal. If the type of the current signal is the first type, then the current transmission channel may not be changed, and the subsequent signal is continuously outputted to the first light receiving element via the third optical passage, during which process the type of the electric signal outputted by the first light receiving element may be continuously detected. If it is detected that the type of the electric signal is the second type, the method may comprise immediately changing the current transmission channel, outputting the subsequent signal to the second light receiving element via the fourth optical passage, continuously detecting the type of the electric signal outputted by the second light receiving element, and when it is determined that the type of the electric signal outputted by the second light receiving element is the first type, immediately switching back to the third optical passage.

Optionally, in order to prevent that, because part of the optical signal corresponding to the electric signal of the second type is inputted into the light receiving element corresponding to the first type, the signal is wasted or the signal is not completely transmitted, a segment of signal that does not contain the to-be-transmitted information may be added into the initial signal segments of the electric signals of the two types emitted by the device at the emitting side.

It should be noted that, in the present embodiment, the type of the electric signal outputted by the light receiving element may be determined by, by the MCU, determining the transmission frequency of the electric signal and performing sampling counting to the electric signal. If it is identified that the transmission frequency of the electric signal is less than a preset frequency threshold (for example, 100 MHz), it can be considered that what is received at this point is the optical signal corresponding to the low-speed auxiliary signal. If the frequency of the transmitted-in signal is greater than the preset frequency threshold, it can be considered that what is transmitted in at this point is the optical signal corresponding to the high-speed data signal.

By using the present embodiment, by detecting whether the low-speed controlling electric signal exists in the high-speed data link and the low-speed controlling link, the type of the electric signal corresponding to the optical signal currently received is determined, whereby the transmission state of the silicon-based light-switching-switch unit at the receiving side is controlled, which may increase the resource utilization ratios of the light receiving elements corresponding to the two types.

In an illustrative embodiment, the method further comprises Step S61.

S61: while the third optical signal is being outputted to the first light receiving element via the third optical passage, controlling the fourth optical passage to be in a disconnecting state.

In an illustrative embodiment, the step of outputting the third optical signal to the first light receiving element via the third optical passage in the second light-switching-switch unit comprises:
controlling the third optical passage to be in a conducting state, and outputting the third optical signal to the first light receiving element via the third optical passage.

Optionally, the method further comprises:
while the fourth optical signal is being outputted to the second light receiving element via the fourth optical passage, controlling the third optical passage to be in a disconnecting state.

In order to prevent that the light-switching-switch unit transmits the optical signals of the two types simultaneously to the same one receiving element, which results in mutual interference between the two types of optical signals, and in order to ensure that the optical signals can be accurately and completely transmitted to the light receiving elements of the corresponding types, the method may comprise, while one type of the optical signals is being transmitted, controlling the optical passage corresponding to that type of the optical signals to be in the conducting state, and switching the optical passage corresponding to the other type of the optical signals to be in the disconnecting state. Here, the conducting state may refer to that the optical signal can be transmitted along the whole of the path of the corresponding optical passage. The disconnecting state may refer to that the optical signal cannot be transmitted along the whole of the path of the corresponding optical passage.

As shown in FIG. 9, in the part a in FIG. 9, when the third optical signal is transmitted, the third optical signal can be transmitted out of the light-switching-switch unit via the third optical passage, but the third optical signal cannot be transmitted out of the light-switching-switch unit via the fourth optical passage. In the part b in FIG. 9, when the fourth optical signal is transmitted, the fourth optical signal can be transmitted out of the light-switching-switch unit via the fourth optical passage, but the fourth optical signal cannot be transmitted out of the light-switching-switch unit via the third optical passage.

By using the present embodiment, while one type of the optical signals is being transmitted, the optical passage corresponding to that type is switched to the conducting state, and the optical passage corresponding to the other type is switched to the disconnecting state, which may prevent transmission failure of the optical signals caused by errors in the transmission of the optical signals, to increase the efficiency of the transmission of the optical signals.

In an illustrative embodiment, the step of controlling the third optical passage to be in the conducting state comprises Step S71.

S71: controlling a third optical-waveguide group in the third optical passage to be in a directly-going-through state, wherein when the third optical-waveguide group is in the directly-going-through state, the third optical passage is in the conducting state, and the third optical-waveguide group comprises one or more optical waveguides.

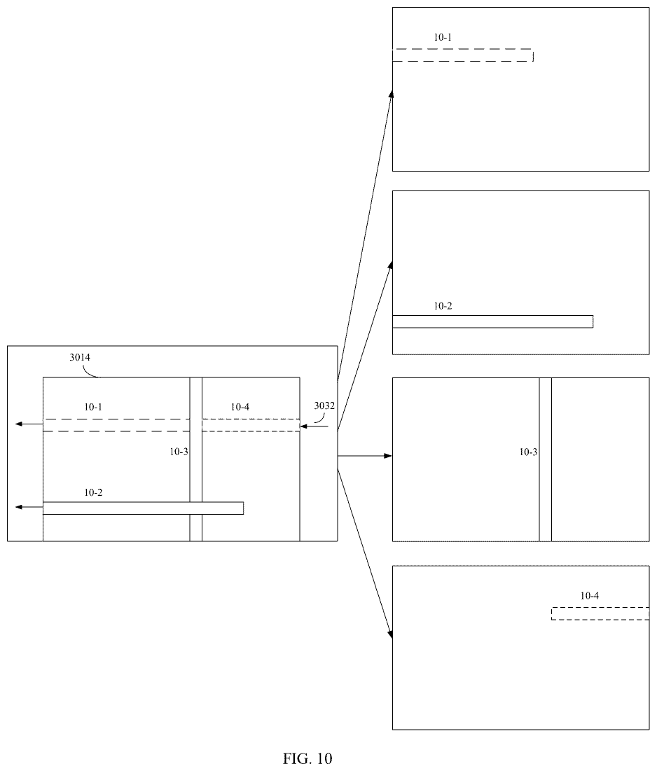

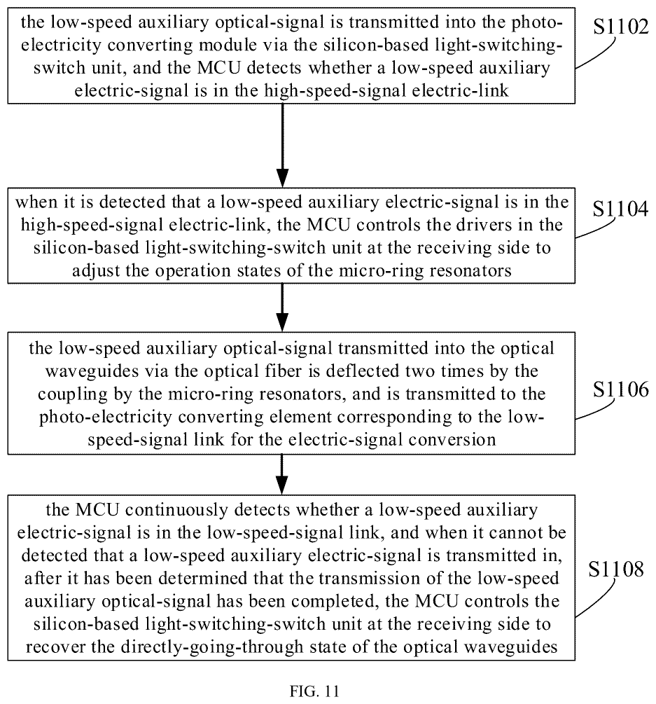

In the present embodiment, the transmission of the optical signal to the light receiving element may also be performed via the optical waveguides. The third optical passage may be formed by the third optical-waveguide group. As shown in FIG. 10, the third optical-waveguide group may comprise one optical waveguide; for example, the passages denoted by 10-1 and 10-4 in FIG. 10 correspond to one optical waveguide. The third optical-waveguide group may also comprise a plurality of optical waveguides; in other words, each of the passages denoted by 10-1 and 10-4 in FIG. 10 corresponds to one optical waveguide. In the third optical-waveguide group, the optical signal can, as shown by the part a in FIG. 9, maintain the direction in which it enters the optical waveguides, and be outputted out of the second light-switching-switch unit. The directly-going-through state according to the present embodiment may be similar to the directly-going-through state corresponding to the above-described first optical-waveguide group, and is not discussed further in the present embodiment.

Optionally, the method further comprises:
while the third optical-waveguide group in the third optical passage is being controlled to be in the directly-going-through state, controlling other optical waveguides than a second target optical waveguide in a fourth optical-waveguide group in the fourth optical passage to be in the directly-going-through state, wherein the second target optical waveguide is an optical waveguide comprised by both of the third optical-waveguide group and the fourth optical-waveguide group, and when the fourth optical-waveguide group is in the directly-going-through state, the fourth optical passage is in a disconnecting state; or while the third optical-waveguide group in the third optical passage is being controlled to be in the directly-going-through state, controlling at least part of other optical waveguides than the second target optical waveguide in the fourth optical-waveguide group in the fourth optical passage to be in a deflecting state, wherein when the at least part of the optical waveguides in the fourth optical-waveguide group are in the deflecting state, the fourth optical passage is in a disconnecting state.

It should be noted that the fourth optical passage may be formed by the fourth optical-waveguide group. As shown in FIG. 10, the fourth optical-waveguide group may comprise a plurality of optical waveguides; in other words, the passages denoted by 10-2 and 10-3 in FIG. 10 correspond to two optical waveguides, and the passage denoted by 10-4 corresponds to one optical waveguide. The second target optical waveguide may be an optical waveguide comprised by both of the third optical-waveguide group and the fourth optical-waveguide group, i.e., the optical waveguide corresponding to the passage denoted by 10-4 in FIG. 10.

When it is required to control the third optical-waveguide group in the third optical passage to be in the directly-going-through state, the fourth optical-waveguide group in the fourth optical passage may be controlled to be also in the directly-going-through state. Because an optical waveguide in the directly-going-through state can transmit the optical signal merely in the direction in which the optical signal enters the optical waveguide, when the fourth optical-waveguide group is in the directly-going-through state, the optical signal cannot enter the optical waveguide shown in FIG. 10 that corresponds to 10-3 connected to the target optical waveguide in the fourth optical-waveguide group, and thus cannot be transmitted to the fourth light receiving element, and the fourth optical passage is in the disconnecting state.

In addition, while the third optical-waveguide group in the third optical passage is being controlled to be in the directly-going-through state, the method may further comprise, while the third optical-waveguide group in the third optical passage is being controlled to be in the directly-going-through state, controlling at least part of other optical waveguides than the second target optical waveguide in the fourth optical-waveguide group in the fourth optical passage to be in the deflecting state. In the deflecting state, the optical signal can be outputted to the direction outside the fourth light receiving element. When the at least part of the optical waveguides in the fourth optical-waveguide group are in the deflecting state, even if the optical signal is transmitted into part of the optical waveguides in the fourth optical-waveguide group, the optical signal entering the fourth optical-waveguide group is deflected, and cannot be outputted to the fourth light receiving element.

It should be noted that the mode of adjusting the states (the directly-going-through state and the deflecting state) of the third optical-waveguide group and the fourth optical-waveguide group by the second light-switching-switch unit may be similar to the mode of adjusting the states of the third optical-waveguide group and the fourth optical-waveguide group by the first light-switching-switch unit in the above embodiment, and is not discussed further in the present embodiment.

For example, when the device is receiving a high-speed data signal or low-speed auxiliary signal in the PCIe protocol via the optical-fiber link, the MCU microcontroller detects the high-speed-signal electric-link and the low-speed-signal electric-link and determines whether the current link is transmitting a low-speed auxiliary signal. If it is not detected that a low-speed auxiliary electric-signal is transmitted in the high-speed-signal electric-link and the low-speed-signal electric-link, the MCU microcontroller controls a driver in the silicon-based light-switching-switch unit at the receiving side, to drive the micro-ring resonators to cause the optical waveguides to be in the directly-going-through state, transmits the optical signal transmitted in via the optical fiber into the high-speed light receiving element in the light receiving unit via the silicon-based light-switching-switch unit at the receiving side, converts into an electric signal, and subsequently transmits via the high-speed-signal electric-link. If it is detected that a low-speed auxiliary electric-signal is transmitted in the high-speed-signal electric-link or the low-speed-signal electric-link, the MCU microcontroller controls a driver in the silicon-based light-switching-switch unit at the receiving side, to drive the micro-ring resonators to cause the optical waveguides to be in the deflecting states, transmits the optical signal transmitted in via the optical fiber into the low-speed light receiving element in the light receiving unit via the silicon-based light-switching-switch unit at the receiving side, converts into an electric signal, and subsequently transmits via the low-speed-signal electric-link.

In the present embodiment, the process of the transmission switching to the signals by the receiving side may comprise Steps S1102-S1108 shown in FIG. 11.

Step S1102: the low-speed auxiliary optical-signal is transmitted into the photo-electricity converting module via the silicon-based light-switching-switch unit, and the MCU detects whether a low-speed auxiliary electric-signal is in the high-speed-signal electric-link.

Step S1104: when it is detected that a low-speed auxiliary electric-signal is in the high-speed-signal electric-link, the MCU controls the drivers in the silicon-based light-switching-switch unit at the receiving side to adjust the operation states of the micro-ring resonators.

Step S1106: the low-speed auxiliary optical-signal transmitted into the optical waveguides via the optical fiber is deflected two times by the coupling by the micro-ring resonators, and is transmitted to the photo-electricity converting element corresponding to the low-speed-signal link for the electric-signal conversion.

Step S1108: the MCU continuously detects whether a low-speed auxiliary electric-signal is in the low-speed-signal link, and when it cannot be detected that a low-speed auxiliary electric-signal is transmitted in, after it has been determined that the transmission of the low-speed auxiliary optical-signal has been completed, the MCU controls the silicon-based light-switching-switch unit at the receiving side to recover the directly-going-through state of the optical waveguides.

By using the present embodiment, the receiving side, by detecting whether the low-speed controlling electric signal exists in the high-speed data link and the low-speed controlling link, controls the transmission state of the silicon-based light-switching-switch unit at the receiving side, and, according to the type of the transmitted signal, determines the state of the optical passage, which may ensure that the electric signal and the optical signal do not interference with each other in the conversion and the transmission, to increase the quality of the signal transmission.

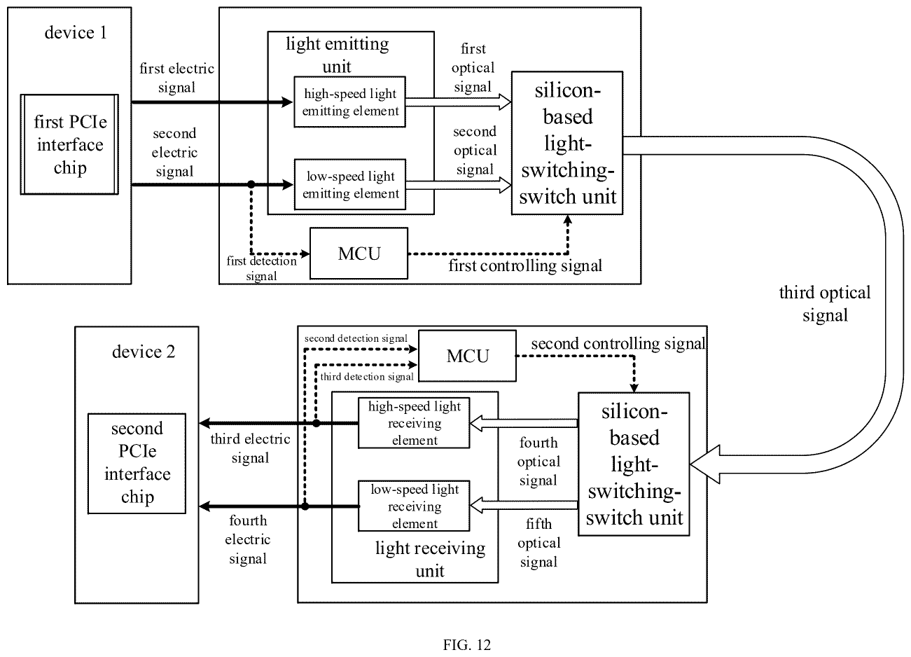

The signal transmitting method according to the embodiments of the present application will be explained and described below with reference to an alternative example. The present alternative example provides a method, device and system for transmitting the optical signal in the PCIe protocol. As shown in FIG. 12, a system for transmitting the signal in the PCIe protocol may be constructed. The system mainly comprises a device 1, a first photo-electricity converting module, an optical fiber, a device 2 and a second photo-electricity converting module. The device 1 comprises a first PCIe interface chip. The first photo-electricity converting module comprises a light emitting unit, a silicon-based light switching switch and an MCU. The device 2 comprises a second PCIe interface chip. The second photo-electricity converting module comprises a light receiving unit, a silicon-based light-switching-switch unit and an MCU.

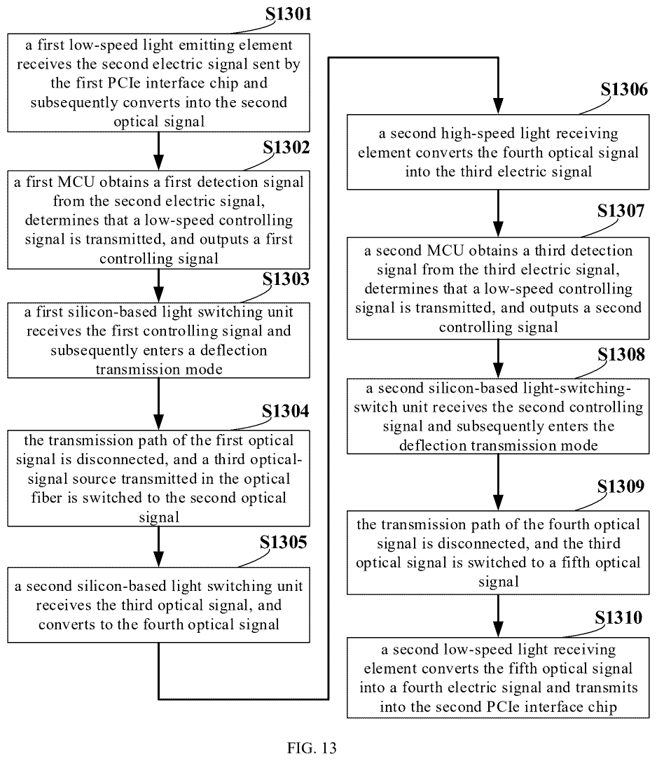

The flow of the signal transmitting method according to the present alternative example may comprise a low-speed signal transmission process and a high-speed signal transmission process. The low-speed signal transmission process may, as shown in FIG. 13, comprise Steps S1301-S1310.

Step S1301: a first low-speed light emitting element receives the second electric signal sent by the first PCIe interface chip and subsequently converts into the second optical signal.

Step S1302: a first MCU obtains a first detection signal from the second electric signal, determines that a low-speed controlling signal is transmitted, and outputs a first controlling signal.

Step S1303: a first silicon-based light switching unit receives the first controlling signal and subsequently enters a deflection transmission mode.

Step S1304: the transmission path of the first optical signal is disconnected, and a third optical-signal source transmitted in the optical fiber is switched to the second optical signal.

Step S1305: a second silicon-based light switching unit receives the third optical signal, and converts to the fourth optical signal.

Step S1306: a second high-speed light receiving element converts the fourth optical signal into the third electric signal.

Step S1307: a second MCU obtains a third detection signal from the third electric signal, determines that a low-speed controlling signal is transmitted, and outputs a second controlling signal.

Step S1308: a second silicon-based light-switching-switch unit receives the second controlling signal and subsequently enters the deflection transmission mode.

Step S1309: the transmission path of the fourth optical signal is disconnected, and the third optical signal is switched to a fifth optical signal.

Step S1310: a second low-speed light receiving element converts the fifth optical signal into a fourth electric signal and transmits into the second PCIe interface chip.

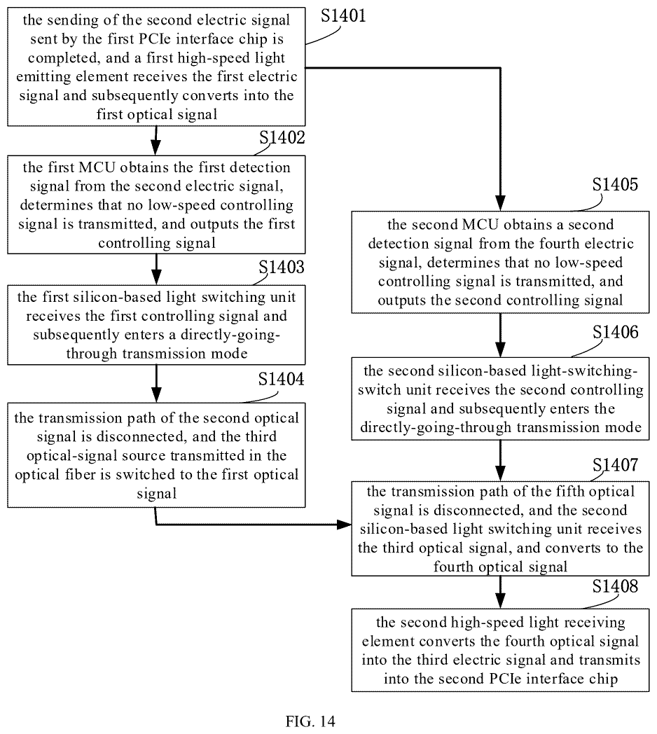

The high-speed signal transmission process may, as shown in FIG. 14, comprise Steps S1401-S1408.

Step S1401: the sending of the second electric signal sent by the first PCIe interface chip is completed, and a first high-speed light emitting element receives the first electric signal and subsequently converts into the first optical signal.

Step S1402: the first MCU obtains the first detection signal from the second electric signal, determines that no low-speed controlling signal is transmitted, and outputs the first controlling signal.

Step S1403: the first silicon-based light switching unit receives the first controlling signal and subsequently enters a directly-going-through transmission mode.

Step S1404: the transmission path of the second optical signal is disconnected, and the third optical-signal source transmitted in the optical fiber is switched to the first optical signal.

Step S1405: the second MCU obtains a second detection signal from the fourth electric signal, determines that no low-speed controlling signal is transmitted, and outputs the second controlling signal.

Step S1406: the second silicon-based light-switching-switch unit receives the second controlling signal and subsequently enters the directly-going-through transmission mode.

Step S1407: the transmission path of the fifth optical signal is disconnected, and the second silicon-based light switching unit receives the third optical signal, and converts to the fourth optical signal.

Step S1408: the second high-speed light receiving element converts the fourth optical signal into the third electric signal and transmits into the second PCIe interface chip.

By using the present alternative example, it may be realized that the PCIe links are constructed via optical fibers between the mainframe such as a server and an external device, and the high-quality transmission of the high-speed data signal and the low-speed auxiliary signal is realized in the optical-fiber links. In addition, by using the characteristics of the resonator formed by the micro-ring resonator and the optical waveguide of a small size and a quick response, quick switching and controlling of the transmission path of the optical signal may be realized, which merely requires the optical fibers required by the transmission of the high-speed optical signal, and saves the optical fibers required by the transmission of the low-speed auxiliary signal, thereby effectively reducing the cost of the photo-electricity converting device.

It should be noted that, regarding the above-described process embodiments, for brevity of the description, all of them are expressed as the combination of a series of actions, but a person skilled in the art should know that the present application is not limited by the sequences of the actions that are described, because, according to the present application, some of the steps may have other sequences or be executed simultaneously. Secondly, a person skilled in the art should also know that all of the embodiments described in the description are preferable embodiments, and not all of the actions and the modules that they involve are required by the present application.

From the description on the above embodiments, a person skilled in the art can clearly know that the method according to the above embodiments may be implemented by means of software plus a necessary generic hardware platform, and, certainly, may also be implemented by hardware, but in many circumstances the former is the preferable embodiment. On the basis of such a comprehension, the substance of the technical solutions of the present application, or the part thereof that makes a contribution over the prior art, may be embodied in the form of a software product. The computer software product is stored in a non-volatile readable storage medium (such as an ROM/RAM, a diskette and an optical disk), and contains multiple instructions configured so that a terminal device (which may be a mobile phone, a computer, a server, a network device and so on) implements the methods according to the embodiments of the present application.

The present embodiment further provides a signal transmitting device, wherein the device is configured for implementing the above embodiments and preferable embodiments, wherein what have been described are not discussed further. As used below, the term “module” may implement the combination of software and/or hardware of predetermined functions. Although the device described in the following embodiments is implemented preferably with software, implementation of hardware, or a combination of software and hardware, is also feasible and envisaged.

The device comprises:
a first light emitting element configured for, in response to the first light emitting element having acquired a first electric signal sent by a first device, converting the first electric signal into a first optical signal, and inputting the first optical signal into a first light-switching-switch unit, wherein the first light emitting element is configured for converting an electric signal of a first type into an optical signal, and the first electric signal is an electric signal of the first type;
a second light emitting element configured for, in response to the second light emitting element having acquired a second electric signal sent by the first device, converting the second electric signal into a second optical signal, and inputting the second optical signal into the first light-switching-switch unit, wherein the second light emitting element is configured for converting an electric signal of a second type into an optical signal, and the second electric signal is an electric signal of the second type; and
the first light-switching-switch unit, connected to the first light emitting element and the second light emitting element, and configured for, in response to the first optical signal being inputted into the first light-switching-switch unit, outputting the first optical signal to an outputting port of the first light-switching-switch unit via a first optical passage in the first light-switching-switch unit, wherein the outputting port is configured for being connected to an optical fiber; and in response to the second optical signal being inputted into the first light-switching-switch unit, outputting the second optical signal to the outputting port via a second optical passage in the first light-switching-switch unit.

In an illustrative embodiment, the device further comprises:
a controller, connected to the first light-switching-switch unit, and configured for, in response to the first optical signal being inputted into the first light-switching-switch unit, controlling the first optical passage to be in a conducting state, and controlling the second optical passage to be in a disconnecting state; and in response to the second optical signal being inputted into the first light-switching-switch unit, controlling the second optical passage to be in the conducting state, and controlling the first optical passage to be in the disconnecting state.

In an illustrative embodiment, the first light-switching-switch unit comprises:
drivers of a quantity N and resonators of the quantity N, wherein the first optical passage comprises a first optical-waveguide group, the first optical-waveguide group comprises optical waveguides of the quantity N, and N is a positive integer greater than or equal to 1; and
the controller is configured for controlling the drivers of the quantity N to be in an operating state or in a non-operating state, in response to an i-th driver among the drivers of the quantity N being in the non-operating state, the i-th driver is configured for stopping driving an i-th resonator among the resonators of the quantity N, to cause an i-th optical waveguide among the optical waveguides of the quantity N to be in a directly-going-through state, wherein i is a positive integer greater than or equal to 1 and less than or equal to N, and when the first optical-waveguide group is in the directly-going-through state, the first optical passage is in the conducting state.

In an illustrative embodiment, the first light-switching-switch unit comprises:
drivers of a quantity M and resonators of the quantity M, wherein the second optical passage comprises a second optical-waveguide group, the first optical passage comprises a first optical-waveguide group, other optical waveguides than a first target optical waveguide in the second optical-waveguide group include the optical waveguides of the quantity M, the first target optical waveguide is an optical waveguide comprised by both of the first optical-waveguide group and the second optical-waveguide group, and M is a positive integer greater than or equal to 1; and
the controller is configured for controlling the drivers of the quantity M to be in an operating state or in a non-operating state, and in response to a j-th driver among the drivers of the quantity M being in the operating state, the j-th driver is configured for driving a j-th resonator among the resonators of the quantity M to cause a j-th optical waveguide among the optical waveguides of the quantity M to be in a deflecting state, wherein j is a positive integer greater than or equal to 1 and less than or equal to M.

In an illustrative embodiment, the device further comprises:
a second light-switching-switch unit, connected to the first light receiving element and the second light receiving element, and configured for, in response to the inputting port of the second light-switching-switch unit having received a third optical signal transmitted via an optical fiber, outputting the third optical signal to the first light receiving element via a third optical passage in the second light-switching-switch unit; and in response to the inputting port of the second light-switching-switch unit having received a fourth optical signal transmitted via an optical fiber, outputting the fourth optical signal to the second light receiving element via a fourth optical passage in the second light-switching-switch unit;
the first light receiving element, configured for converting the third optical signal into a third electric signal, wherein the first light receiving element is configured for converting an optical signal into an electric signal of the first type, and the third electric signal is an electric signal of the first type; and
the second light receiving element, configured for converting the fourth optical signal into a fourth electric signal, wherein the second light receiving element is configured for converting an optical signal into an electric signal of the second type, and the fourth electric signal is an electric signal of the second type.

An embodiment of the present application further provides a non-volatile computer-readable storage medium, wherein the non-volatile computer-readable storage medium stores a computer program, and the computer program is configured for, when executed, implementing the steps according to any one of the process embodiments stated above.

In an illustrative embodiment, the non-volatile computer-readable storage medium may include but is not limited to various media that can store a computer program, such as a USB flash disk, a Read-Only Memory (referred to for short as ROM), a Random Access Memory (referred to for short as RAM), a mobile hard disk drive, a diskette and an optical disk

An embodiment of the present application further provides an electronic device, wherein the electronic device comprises a memory and a processor, the memory stores a computer program, and the processor is configured for executing the computer program to implement the steps according to any one of the process embodiments stated above.

In an illustrative embodiment, the electronic device may further comprise a transmitting device and an inputting-outputting device, wherein the transmitting device is connected to the processor, and the inputting-outputting device is connected to the processor.

The particular examples in the present embodiment may refer to the examples described in the above embodiments and illustrative embodiments, and are not discussed further in the present embodiment.

Apparently, a person skilled in the art should understand that the modules or steps described above according to the present application may be embodied by using generic computing devices. They may be concentrated in a single computing device, or distributed in a network formed by a plurality of computing devices. They may be embodied by using a program code executable by a computing device, whereby they may be stored in a storing device and executed by the computing device. Furthermore, in some cases, the illustrated or described steps may be executed in sequences different from the sequences used herein, or they may be separately fabricated into integrated-circuit modules, or a plurality of modules or steps among them may be fabricated into a single integrated-circuit module to be embodied. Accordingly, the present application is not limited to any particular combination of hardware and software.

The above are merely preferable embodiments of the present application, and are not indented to limit the present application. For a person skilled in the art, the present application may have various modifications and variations. Any modifications, equivalent substitutions and improvements that are made within the principle of the present application should fall within the protection scope of the present application.

1. A signal transmitting method, wherein
the method comprises:
in response to a first light emitting element having acquired a first electric signal sent by a first device, by using the first light emitting element, converting the first electric signal into a first optical signal, inputting the first optical signal into a first light-switching-switch unit, and outputting the first optical signal to an outputting port of the first light-switching-switch unit via a first optical passage in the first light-switching-switch unit, wherein the first light emitting element is configured for converting an electric signal of a first type into an optical signal, the first electric signal is an electric signal of the first type, and the outputting port is connected to an optical fiber; and
in response to a second light emitting element having acquired a second electric signal sent by the first device, by using the second light emitting element, converting the second electric signal into a second optical signal, inputting the second optical signal into the first light-switching-switch unit, and outputting the second optical signal to the outputting port of the first light-switching-switch unit via a second optical passage in the first light-switching-switch unit, wherein the second light emitting element is configured for converting an electric signal of a second type into an optical signal, and the second electric signal is an electric signal of the second type.

2. The method according to claim 1, wherein
the method further comprises:
in response to the first light emitting element having acquired the first electric signal sent by the first device and the second light emitting element having acquired the second electric signal sent by the first device, inputting the second optical signal into the first light-switching-switch unit, and determining whether the whole of the second electric signal has been outputted to the outputting port; and
in response to it having been determined that the whole of the second electric signal has been outputted to the outputting port, inputting the first optical signal into the first light-switching-switch unit.

3. The method according to claim 1, wherein
the method further comprises:
while the first optical signal is being outputted to the outputting port via the first optical passage, controlling the second optical passage to be in a disconnecting state.

4. The method according to claim 1, wherein
the method further comprises:
while the second optical signal is being outputted to the outputting port via the second optical passage, controlling the first optical passage to be in a disconnecting state.

5. The method according to claim 1, wherein
the step of outputting the first optical signal to the outputting port of the first light-switching-switch unit via the first optical passage in the first light-switching-switch unit comprises:
controlling the first optical passage to be in a conducting state, and outputting the first optical signal to the outputting port via the first optical passage.

6. The method according to claim 5, wherein
the step of controlling the first optical passage to be in the conducting state comprises:
controlling a first optical-waveguide group in the first optical passage to be in a directly-going-through state, wherein when the first optical-waveguide group is in the directly-going-through state, the first optical passage is in the conducting state, and the first optical-waveguide group comprises one or more optical waveguides.

7. (canceled)

8. (canceled)

9. (canceled)

10. The method according to claim 1, wherein
the step of outputting the second optical signal to the outputting port of the first light-switching-switch unit via the second optical passage in the first light-switching-switch unit comprises:
controlling the second optical passage to be in a conducting state, and outputting the second optical signal to the outputting port via the second optical passage.

11. The method according to claim 10, wherein
the step of controlling the second optical passage to be in the conducting state comprises:
controlling a second optical-waveguide group in the second optical passage to be in a deflecting state, wherein when the second optical-waveguide group is in the deflecting state, the second optical passage is in the conducting state, and the second optical-waveguide group comprises one or more optical waveguides.

12. (canceled)

13. (canceled)

14. (canceled)

15. The method according to claim 1, wherein
the method further comprises:
in response to an inputting port of a second light-switching-switch unit having received a third optical signal transmitted via an optical fiber, outputting the third optical signal to a first light receiving element via a third optical passage in the second light-switching-switch unit, and by using the first light receiving element, converting the third optical signal into a third electric signal, wherein the first light receiving element is configured for converting an optical signal into an electric signal of the first type, and the third electric signal is an electric signal of the first type; and
in response to the inputting port of the second light-switching-switch unit having received a fourth optical signal transmitted via an optical fiber, outputting the fourth optical signal to a second light receiving element via a fourth optical passage in the second light-switching-switch unit, and by using the second light receiving element, converting the fourth optical signal into a fourth electric signal, wherein the second light receiving element is configured for converting an optical signal into an electric signal of the second type, and the fourth electric signal is an electric signal of the second type.

16. The method according to claim 15, wherein
the method further comprises:
in response to the inputting port of the second light-switching-switch unit having received a target optical signal transmitted via an optical fiber, outputting the target optical signal to the first light receiving element via the third optical passage, and by using the first light receiving element, converting the target optical signal into a target electric signal;
acquiring a first transmission frequency of the target electric signal;
in response to the first transmission frequency being less than a preset frequency threshold, determining the target electric signal to be an electric signal of the second type, and determining an optical signal after a moment when the inputting port of the second light-switching-switch unit has received the target optical signal to be the third optical signal; and
in response to the first transmission frequency being greater than or equal to the preset frequency threshold, determining the target electric signal to be an electric signal of the first type, and determining the optical signal after the moment when the inputting port of the second light-switching-switch unit has received the target optical signal to be the fourth optical signal.

17. The method according to claim 15, wherein
the method further comprises:
while the third optical signal is being outputted to the first light receiving element via the third optical passage, controlling the fourth optical passage to be in a disconnecting state.

18. The method according to claim 15, wherein
the method further comprises:
while the fourth optical signal is being outputted to the second light receiving element via the fourth optical passage, controlling the third optical passage to be in a disconnecting state.

19. The method according to claim 15, wherein
the step of outputting the third optical signal to the first light receiving element via the third optical passage in the second light-switching-switch unit comprises:
controlling the third optical passage to be in a conducting state, and outputting the third optical signal to the first light receiving element via the third optical passage.

20. (canceled)

21. (canceled)

22. A signal transmitting device, wherein
the device comprises:
a first light emitting element configured for, in response to the first light emitting element having acquired a first electric signal sent by a first device, converting the first electric signal into a first optical signal, and inputting the first optical signal into a first light-switching-switch unit, wherein the first light emitting element is configured for converting an electric signal of a first type into an optical signal, and the first electric signal is an electric signal of the first type;
a second light emitting element configured for, in response to the second light emitting element having acquired a second electric signal sent by the first device, converting the second electric signal into a second optical signal, and inputting the second optical signal into the first light-switching-switch unit, wherein the second light emitting element is configured for converting an electric signal of a second type into an optical signal, and the second electric signal is an electric signal of the second type; and
the first light-switching-switch unit, connected to the first light emitting element and the second light emitting element, and configured for, in response to the first optical signal being inputted into the first light-switching-switch unit, outputting the first optical signal to an outputting port of the first light-switching-switch unit via a first optical passage in the first light-switching-switch unit, wherein the outputting port is configured for being connected to an optical fiber; and in response to the second optical signal being inputted into the first light-switching-switch unit, outputting the second optical signal to the outputting port via a second optical passage in the first light-switching-switch unit.

23. The device according to claim 22, wherein
the device further comprises:
a controller, connected to the first light-switching-switch unit, and configured for, in response to the first optical signal being inputted into the first light-switching-switch unit, controlling the first optical passage to be in a conducting state, and controlling the second optical passage to be in a disconnecting state; and in response to the second optical signal being inputted into the first light-switching-switch unit, controlling the second optical passage to be in the conducting state, and controlling the first optical passage to be in the disconnecting state.

24. The device according to claim 23, wherein
the first light-switching-switch unit comprises:
drivers of a quantity N and resonators of the quantity N, wherein the first optical passage comprises a first optical-waveguide group, the first optical-waveguide group comprises optical waveguides of the quantity N, and N is a positive integer greater than or equal to 1; and
the controller is configured for controlling the drivers of the quantity N to be in an operating state or in a non-operating state, in response to an i-th driver among the drivers of the quantity N being in the non-operating state, the i-th driver is configured for stopping driving an i-th resonator among the resonators of the quantity N, to cause an i-th optical waveguide among the optical waveguides of the quantity N to be in a directly-going-through state, wherein i is a positive integer greater than or equal to 1 and less than or equal to N, and when the first optical-waveguide group is in the directly-going-through state, the first optical passage is in the conducting state.

25. The device according to claim 23, wherein
the first light-switching-switch unit comprises:
drivers of a quantity M and resonators of the quantity M, wherein the second optical passage comprises a second optical-waveguide group, the first optical passage comprises a first optical-waveguide group, other optical waveguides than a first target optical waveguide in the second optical-waveguide group include the optical waveguides of the quantity M, the first target optical waveguide is an optical waveguide comprised by both of the first optical-waveguide group and the second optical-waveguide group, and M is a positive integer greater than or equal to 1; and
the controller is configured for controlling the drivers of the quantity M to be in an operating state or in a non-operating state, and in response to a j-th driver among the drivers of the quantity M being in the operating state, the j-th driver is configured for driving a j-th resonator among the resonators of the quantity M to cause a j-th optical waveguide among the optical waveguides of the quantity M to be in a deflecting state, wherein j is a positive integer greater than or equal to 1 and less than or equal to M.

26. The device according to claim 23, wherein
the device further comprises:
a second light-switching-switch unit, connected to the first light receiving element and the second light receiving element, and configured for, in response to the inputting port of the second light-switching-switch unit having received a third optical signal transmitted via an optical fiber, outputting the third optical signal to the first light receiving element via a third optical passage in the second light-switching-switch unit; and in response to the inputting port of the second light-switching-switch unit having received a fourth optical signal transmitted via an optical fiber, outputting the fourth optical signal to the second light receiving element via a fourth optical passage in the second light-switching-switch unit;
the first light receiving element, configured for converting the third optical signal into a third electric signal, wherein the first light receiving element is configured for converting an optical signal into an electric signal of the first type, and the third electric signal is an electric signal of the first type; and
the second light receiving element, configured for converting the fourth optical signal into a fourth electric signal, wherein the second light receiving element is configured for converting an optical signal into an electric signal of the second type, and the fourth electric signal is an electric signal of the second type.

27. A non-volatile computer-readable storage medium, wherein
the non-volatile computer-readable storage medium stores a computer program, and the computer program, when executed by a processor, implements the method according to claim 1.

28. An electronic device, comprising a memory, a processor, and a computer program that is stored in the memory and executable in the processor, wherein the processor, when executing the computer program, implements the method according to claim 1.
